(19) United States
(12) Patent Application Publication
(10) Pub. No.: US 2024/0354593 A1
(43) Pub. Date: Oct. 24, 2024

(54) Scaling Heteroscedastic Classifiers for Large Numbers of Classes

(71) Applicant: Google LLC, Mountain View, CA (US)

(72) Inventors: Rodolphe René Willy Jenatton, Berlin (DE); Mark Patrick Collier, Zurich (CH); Effrosyni Kokiopoulou, Horgen (CH); Basil Mustafa, Zurich (CH); Neil Matthew Tinmouth Houlsby, Zurich (CH); Jesse Berent, Geneva (CH)

(21) Appl. No.: 18/355,672

(22) Filed: Jul. 20, 2023

(30) Foreign Application Priority Data
Apr. 24, 2023 (GR) 20230100342

(51) Int. Cl. G06N 3/0985; G06N 3/048

(52) U.S. Cl. CPC G06N 3/0985; G06N 3/048

(57) ABSTRACT

HET classifiers, which learn a multivariate Gaussian distribution over prediction logits, perform well on image classification problems with hundreds to thousands of classes. However, compared to standard classifiers (e.g., deterministic (DET) classifiers), they introduce extra parameters that scale linearly with the number of classes. This makes them infeasible to apply to larger-scale problems. In addition, HET classifiers introduce a temperature hyperparameter, which is ordinarily tuned. HET classifiers are disclosed, where the parameter count (when compared to a DET classifier) scales independently of the number of classes. In large-scale settings of the embodiments, the need to tune the temperature hyperparameter is removed, by directly learning it on the training data.

### PRIORITY CLAIM

The present application is based on and claims priority to Greek application 20230100342 having a filing date of Apr. 24, 2023, which is incorporated by reference herein.

### FIELD

The present disclosure relates generally to classifier models. More particularly, the present disclosure relates to scaling heteroscedastic classifiers for large numbers of classes.

### BACKGROUND

Deterministic (DET) classifier models have been deployed for various tasks such as classifying images via the classes of objects depicted in them. However, the performance of DET classifier models tends to degrade when uncertainty in the classes (or labels) of the model increases. That is, when differences between at least some of the classes are subtle and/or small, the classification of examples between the “close” classes becomes noisy. For instance, classifiers that are trained to recognize different breeds of dogs depicted in images may have noisy labels, at least because humans labeling training datasets may sometimes fail to properly distinguish between “close” breeds. Thus, the labels of the training data may be “noisy.” The performance of DET classifier models with noisy labels tends to degrade. As the number of classes scale to large values (e.g., tens of thousands of classes), the labels (or classes) tend to get nosier at least because the differences between classes tends to be smaller as the number of classes scale. Thus, implementing DET classifiers, as the number of classes scale, may not be feasible for some classifier tasks.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method that includes generating, by a computing device, a first vector based on an embedding model operating on an input object. The first vector is embedded within a first vector space that has a first number of dimensions. The computing device generate a second vector based on combining the first vector with a noise vector. The second vector and the noise vector are embedded in the first vector space. The noise vector is based on a covariance associated with a set of components of the first vector. The computing device generates a third vector based on the second vector and a logit function. The logit function embeds the second vector in a second vector space that has a second number of dimensions that is greater than the first number of dimensions and is equivalent to a number of classes of a heteroscedastic (HET) classifier model. The computing device trains the HET classifier model based on the third vector.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that performs training, deploying, and implementing heteroscedastic classifier models according to example embodiments of the present disclosure.

FIG. 1B depicts a block diagram of an example computing device that performs training, deploying, and implementing heteroscedastic classifier models according to example embodiments of the present disclosure.

FIG. 1C depicts a block diagram of an example computing device that performs training, deploying, and implementing heteroscedastic classifier models according to example embodiments of the present disclosure.

FIG. 2A depicts a block diagram of a first example of a heteroscedastic classifier model, according to various embodiments.

FIG. 2B depicts a block diagram of a second example of a heteroscedastic classifier model, according to various embodiments.

FIG. 3 depicts a flow chart diagram of an example method 300 to train a heteroscedastic classifier model according to example embodiments of the present disclosure.

Reference numerals that are repeated across plural figures are intended to identify the same features in various implementations.

### DETAILED DESCRIPTION

### Overview

Generally, the present disclosure is directed to heteroscedastic (HET) classifiers (or HET classifier models) that may be implemented as the number of classes of the of the HET model scales to massively large values. That is, the embodiments are directed towards massively scaling HET classifier models. The HET models of the embodiments may classify input objects as one or more of K classes, where K is a large positive integer. For instance, K may be an integer within the interval [10³-10⁷]. In some embodiments, K may be on the order of tens of thousands, or even hundreds of thousands of classes for a HET model. In some embodiments, an HET classifier model may assign, for a given input object, a separate probability for each of the K classes. In various embodiments, an HET model may be implemented via one or more neural network layers. Accordingly, an HET model (or a HET classifier model) may be referred to as a HET layer and/or HET layers.

HET classifiers, which learn a multivariate Gaussian distribution over prediction logits, perform well on image classification problems with hundreds to thousands of classes. However, compared to standard classifiers (e.g., deterministic (DET) classifiers), they introduce extra parameters that scale linearly with the number of classes. This makes them infeasible to apply to larger-scale problems. In addition, HET classifiers introduce a temperature hyperparameter, which is ordinarily tuned. For some HET classifiers of the embodiments, the parameter count (when compared to a DET classifier) scales independently of the number of classes (e.g., K). In large-scale settings of the embodiments, the need to tune the temperature hyperparameter is removed, by directly learning it on the training data.

The HET models of the embodiments are distinguished from DET classifier models by an input-dependent noise term that captures uncertainty in the model's predictions. The HET classifier models of the embodiments learn the noise term in training. Because DET models do not incorporate such a noise term, HET classifier models that adequately model the noise generally perform better than DET classifier models. However, as discussed below, due to modeling of the noise, HET classifier models generally include more parameters (and are thus more computationally complex) than corresponding DET models. As also discussed below, the number of parameters for some HET classifier models scales supralinearly, with respect to the number of classes of the model (e.g., K). Thus, as K scales to large values, at least some HET classifier models may be impractical to implement because the number of model parameters becomes unfeasible. At least some HET classifiers of the embodiments include significantly less parameters than these other (e.g., “difficult-to-scale”) HET classifiers, and are thus feasible to implement as K scales to large values. As discussed below, these scalable HET classifiers also have significant improved performance over both DET classifiers and the “difficult-to-scale” HET classifiers.

The input-dependent noise term of the scalable HET classifier embodiments may be a D-dimensional vector that is calculated based on a D×D covariance matrix, where D is a positive integer that is less than K. In some embodiments D<<K. The covariance matrix is learned in training. In some embodiments, the covariance matrix may be approximated (e.g., parameterized) via R parameters, where R is another positive integer. In some embodiments, R<D<<K. The parameterization of the covariance matrix may be learned in training. In other HET models (e.g., “difficult-to-scale” embodiments), the covariance matrix is a K×K matrix. The embodiments that calculate the noise term based on a D×D covariance matrix are significantly less computationally complex than those that calculate the noise term based on a K×K covariance matrix because D²<<K². In the various embodiments, D may be at least somewhat independent of K. Thus, as K scales to a large value (e.g., ˜tens or hundreds of thousands), D need not scale with K. Because D²<<K², as K scales to large values, an HET model of the embodiments may be trained and implemented without scaling up the hardware requirements.

Various HET models include a generative process that approximates a discrete choice for assigning one or more classes to an input object. The generative process is regulated via a temperature parameter (t). The choice of the value for the temperature parameter regulates a bias-variance trade-off between the bias with respect to the generative process and a variance of an estimate (e.g., a parameterization) for the noise term. Some HET models treat the temperature parameter as a hyperparameter for the model. The value of the temperature parameter (e.g., treated as a hyperparameter) may be determined by sweeping through a range of possible values, and selecting a value based on its performance (e.g., a model validation stage). Selecting a value for the temperature parameter by sweeping through discrete possible values (e.g., at a sufficiently small step size) may be computationally expensive and/or cumbersome. In contrast to these HET models, at least some of the embodiments “learn” an optimal (or at least close to optimal) value for the temperature parameter during the model's training. That is, the embodiments do not treat the temperature parameter as a hyperparameter, but rather as a parameter of the model to learn in training. This further increases the model's efficiency in training and deployment.

The HET models of the embodiments may be employed in various deep learning use cases. For instance, the HET models of the embodiments may be employed in large-scale image classification (e.g., classify images based on one or more objects depicted in the image) tasks, image segmentation, regression-based applications, uncertainty quantification applications, bandit (e.g., multi-armed bandit) problems, and the like. More generally, the HET models of the embodiments may be deployed in various applications that include classifying input objects in one or more of a large number of classes. The input to a classification task may be a data object (e.g., an image) to be classified. The output of the HET model deployed to the classification may be a probability value (e.g., a value between 0.0 and 1.0) for each of the K classes of the model. In some embodiments, the classification tasks may apply one or more probability thresholds, and assign one or more classes to the input object. For instance, an input object may be an image that depicts a dog. The K classes may include various dog breeds. For each dog breed, the classification tasks may assign a probability value to the image. In some embodiments, a single probability threshold is used for each of the K classes. In other embodiments, a separate probability threshold is assigned to each of the K classes.

As discussed above, the “extra parameter” count (as compared to DET models) for at least some HET classifier models of the embodiments may scale less than linearly with the scaling of the number of classes (e.g., K). For reasons discussed below, these HET classifier models may be referred to as “noise-before-logits” and/or “scalable” models. In other embodiments, the extra parameter count scales supralinearly with the K. In these embodiments, K logit values are generated for an object (e.g., an image) provided to the HET classifier. These HET classifier models may be referred to as “logits-before-noise” and/or “difficult-to-scale” models. In both “noise-before-logits” and “logits-before-noise” models, an input object (e.g., an image) is provided to the model. The model generates a D dimensional embedding vector of the model. As noted above, in at least some embodiments, D<<K.

In “logits-before-noise” models, K logit values are generated for the input object based on the D-dimensional embedding vector. The K logit values are encoded in a vector embedded in a K-dimensional “logit space.” After generating the K logit values (e.g., encoded in the components of the K-dimensional logit vector), noise is added to each component of the K-dimensional logit vector. That is, in “logit-before-noise” models, the noise is added in the K-dimensional logit space. The noise term of the K-dimensional logit space is based on a K×K covariance matrix. After the K components of noise is added to the K logit components, probabilities are generated for each of the K classes based on an activation function (e.g., softmax, sigmoid, or the like).

In contrast to “logits-before-noise” models, the noise for “noise-before-logits” models, is added in the D-dimensional “pre-logit space” of the embedding vector. In these “noise-before-logit” models, a D-dimensional noise vector is combined with the D-dimensional embedding vector. The D-dimensional noise vector is based on a D×D covariance matrix. After adding the noise in the pre-logit vector space, K logits and K corresponding probabilities are generated in a manner similar to that of the “logits-before-noise” models. Because D²<<K², the number of parameters required for a “noise-before-logits” model is significantly less than the number of parameters required for a “logits-before-noise” model.

Aspects of the present disclosure provide a number of technical effects and benefits. As one example technical effect and benefit, computational efficiency for training and deploying a HET classifier model is increased due to the significant reduction is model parameters required for “noise-before-logits” embodiments. As a result, the usage of computing resources can be reduced. For example, the number of processor cycles can be reduced, the usage of computer memory can be reduced, and/or the usage of network bandwidth can be reduced. Furthermore, a significant reduction in training time is achieved by treating the temperature parameter as a “learnable” parameter that is learned during model training. Also, a significant increase in model performance (over DET classifiers and other HET classifiers) is achieved in the embodiments.

A technical effect of example implementations of the present disclosure is increased energy efficiency in performing operations using machine-learned models, thereby improving the functioning of computers implementing such models. For instance, example implementations can provide for more energy-efficient runtime execution or inference. In some scenarios, increased energy efficiency can provide for less energy to be used to perform a given task (e.g., less energy expended to maintain the model in memory, less energy expended to perform calculations within the model, etc.). In some scenarios, increased energy efficiency can provide for more task(s) to be completed for a given energy budget (e.g., a larger quantity of tasks, more complex tasks, the same task but with more accuracy or precision, etc.).

In another example aspect, example implementations can provide for more energy-efficient training operations or model updates. In some scenarios, increased energy efficiency can provide for less energy to be used to perform a given number of update iterations (e.g., less energy expended to maintain the model in memory, less energy expended to perform calculations within the model, such as computing gradients, backpropagating a loss, etc.). In some scenarios, increased energy efficiency can provide for more update iterations to be completed for a given energy budget (e.g., a larger quantity of iterations, etc.). In some scenarios, greater expressivity afforded by model architectures and training techniques of the present disclosure can provide for a given level of functionality to be obtained in fewer training iterations, thereby expending a smaller energy budget. In some scenarios, greater expressivity afforded by model architectures and training techniques of the present disclosure can provide for an extended level of functionality to be obtained in a given number of training iterations, thereby more efficiently using a given energy budget.

In this manner, for instance, the improved energy efficiency of example implementations of the present disclosure can reduce an amount of pollution or other waste associated with implementing machine-learned models and systems, thereby advancing the field of machine-learning and artificial intelligence as a whole. The amount of pollution can be reduced in toto (e.g., an absolute magnitude thereof) or on a normalized basis (e.g., energy per task, per model size, etc.). For example, an amount of CO2 released (e.g., by a power source) in association with training and execution of machine-learned models can be reduced by implementing more energy-efficient training or inference operations. An amount of heat pollution in an environment (e.g., by the processors/storage locations) can be reduced by implementing more energy-efficient training or inference operations.

With reference now to the Figures, example embodiments of the present disclosure will be discussed in further detail.

### Example Devices and Systems

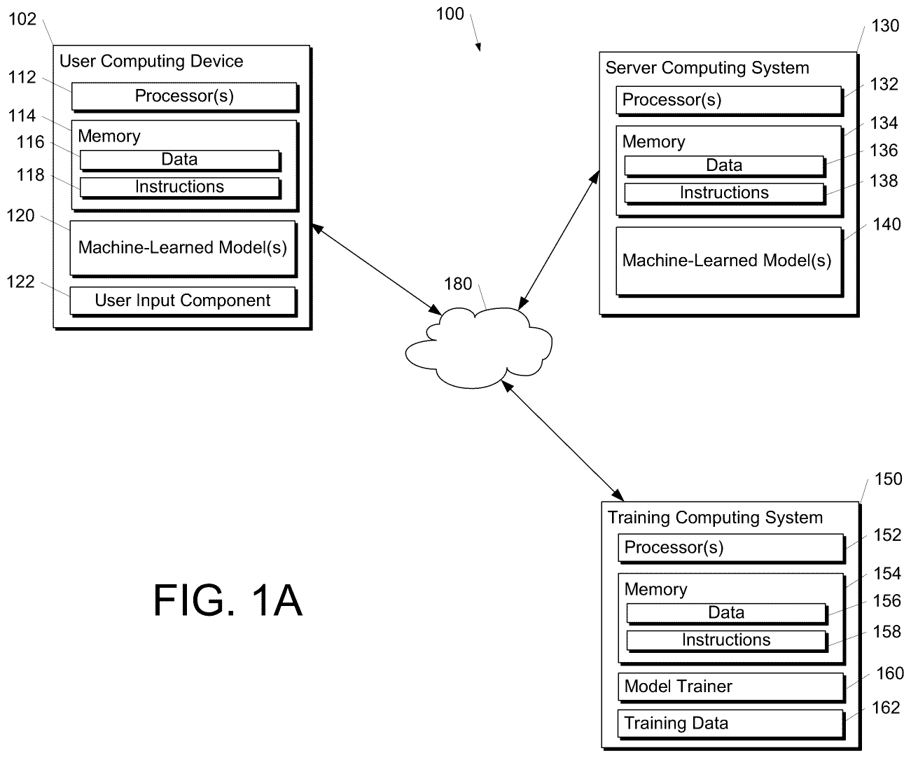

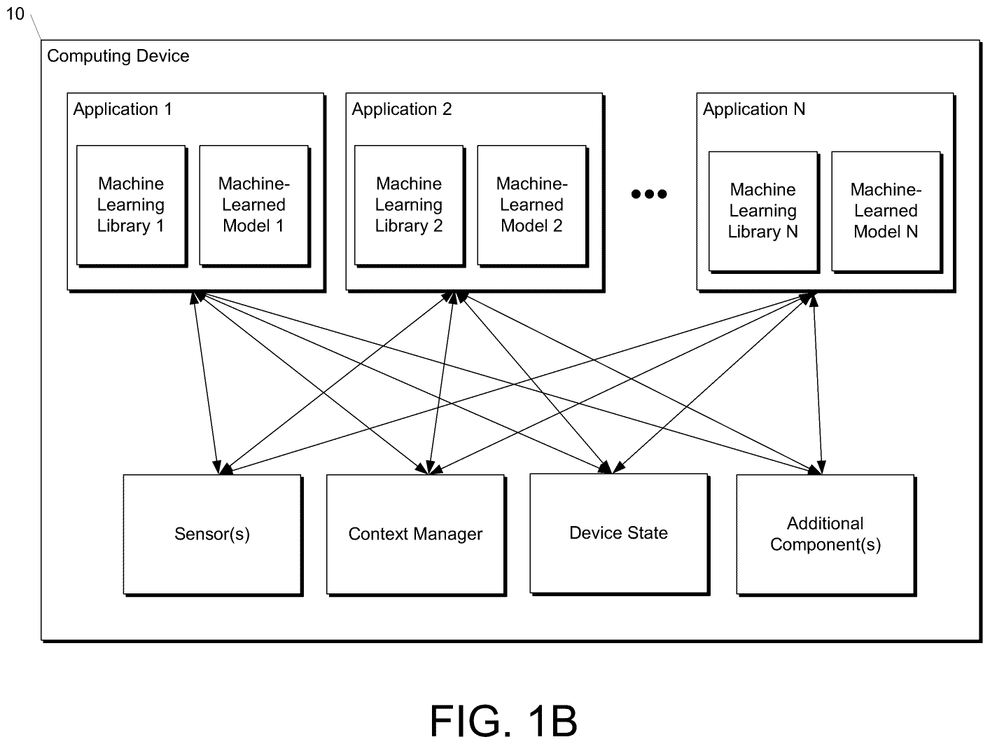

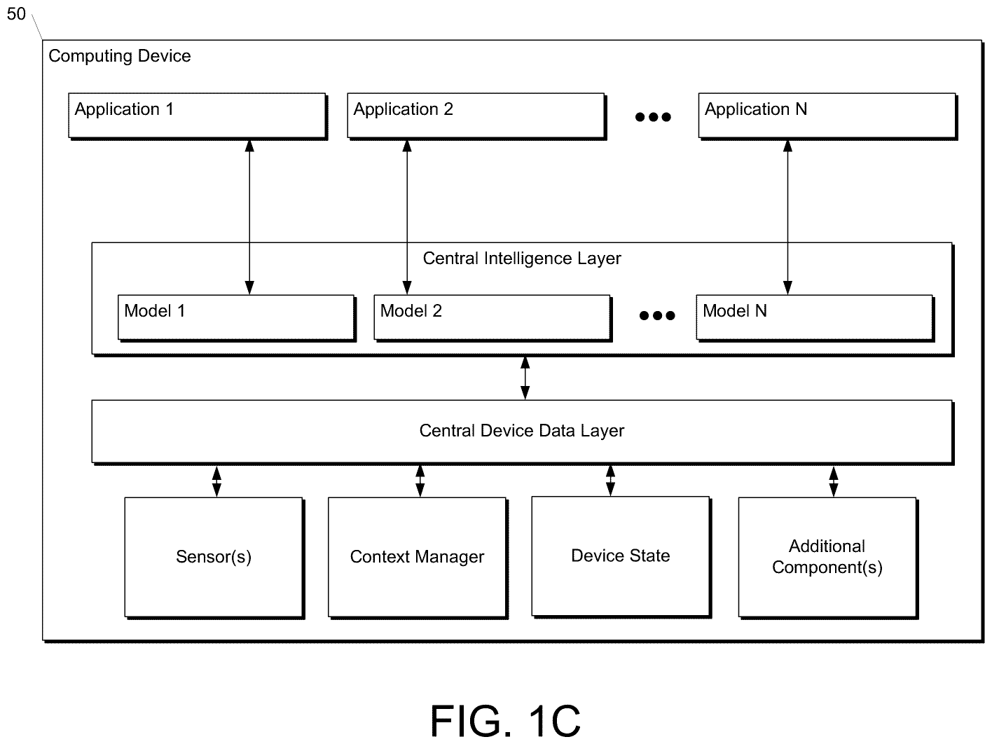

FIG. 1A depicts a block diagram of an example computing system 100 that performs training, deploying, and implementing heteroscedastic classifier models, according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

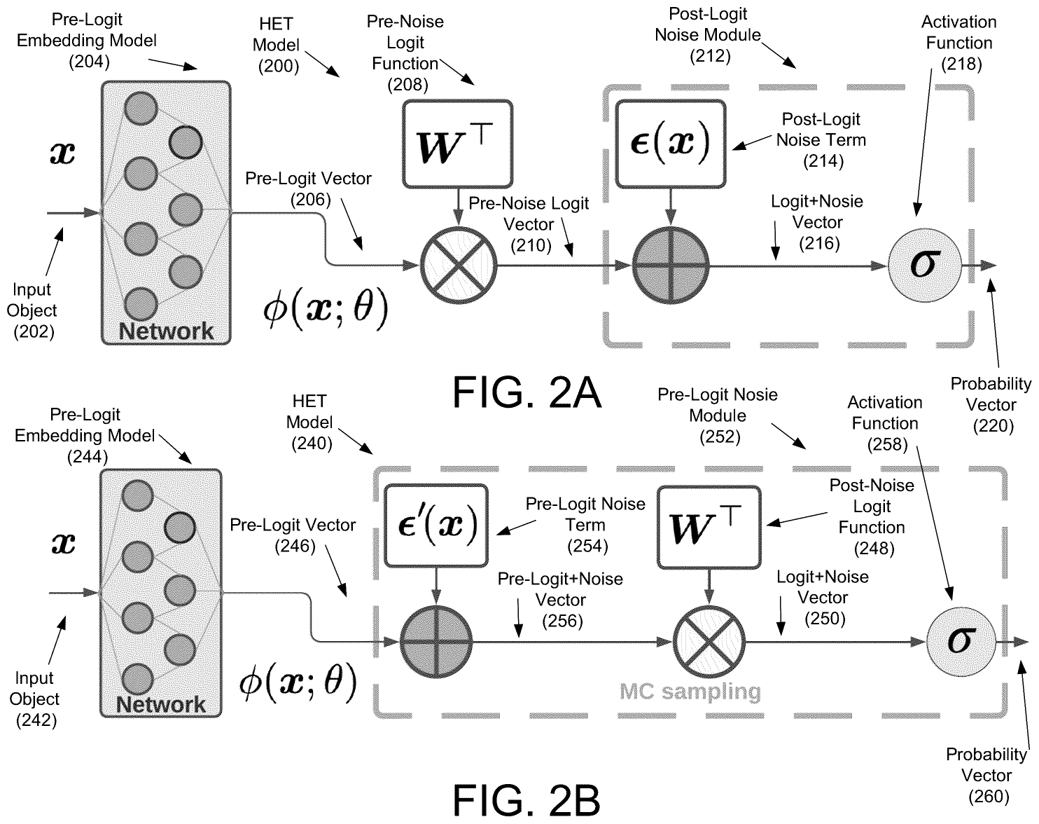

In some implementations, the user computing device 102 can store or include one or more heteroscedastic (HET) classifier models 120. For example, the HET classifier models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example HET classifier models 120 are discussed with reference to FIGS. 2A-2B.

In some implementations, the one or more HET classifier models 120 can be received from the server computing system 130 over network 180, stored in the user computing device memory 114, and then used or otherwise implemented by the one or more processors 112. In some implementations, the user computing device 102 can implement multiple parallel instances of a single HET classifier model 120

Additionally or alternatively, one or more HET classifier models 140 can be included in or otherwise stored and implemented by the server computing system 130 that communicates with the user computing device 102 according to a client-server relationship. For example, the HET classifier models 140 can be implemented by the server computing system 100 as a portion of a web service (e.g., a classifier service). Thus, one or more models 120 can be stored and implemented at the user computing device 102 and/or one or more HET classifier models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more HET classifier models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 2A-2B.

The user computing device 102 and/or the server computing system 130 can train the HET classifier models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the HET classifier models 120 and/or 140 based on a set of training data 162. The training data 162 can include, for example, labeled training examples such that supervised learning techniques (e.g., gradient descent) can be employed.

In some implementations, if the user has provided consent, the training examples can be provided by the user computing device 102. Thus, in such implementations, the HET classifier model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 1A illustrates one example computing system that can be used to implement the present disclosure. Other computing systems can be used as well. For example, in some implementations, the user computing device 102 can include the model trainer 160 and the training dataset 162. In such implementations, the HET classifier models 120 can be both trained and used locally at the user computing device 102. In some of such implementations, the user computing device 102 can implement the model trainer 160 to personalize the HET classifier models 120 based on user-specific data.

FIG. 1B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

### “Logits-Before-Noise” HET Classifier Models

FIG. 2A depicts a block diagram of a first example of a heteroscedastic (HET) classifier model 200, according to various embodiments. In the language used above, HET classifier model 200 of FIG. 2A may be a “logits-before-noise” and/or a “difficult-to-scale” HET classifier model. Details of HET classifier model 200 are discussed in detail below. However, briefly, HET classifier model 200 includes a pre-logit embedding model 204 that receives an input object 202. The input object 202 may be referred to as x. The pre-logit embedding model 204 may be representable as a function (e.g., ϕ(;θ)) that is parameterized by a vector (or set) of parameters θ. Based on the input object 202, the pre-logit embedding model 204 generates a pre-logit vector 206 (e.g., ϕ(x;θ)). The pre-logit vector 206 may be embedded within a D-dimensional pre-logit vector space, where D is a positive integer. A pre-noise logit function 208 (e.g., W^{T}) generates a pre-noise logit vector 210 based on the pre-logit vector 206. The pre-noise logit vector 210 may be embedded in a K-dimensional post-logit vector space, where K is a positive integer that corresponds to the number of classes associated with the HET classifier model 200. In various embodiments, D<K. In at least one embodiment, D<<K.

The pre-noise logit vector 210 is provided to a post-logit noise module 212. A post-logit noise term 214 (e.g., K-dimensional noise vector ϵ(x)) adds noise to each component of the pre-noise logit vector 210 (e.g., embedded in the K-dimensional post-logit space) to generate a logit+noise vector 216 (e.g., embedded in the K-dimension post-logit space). The post-logit noise term 214 may be a vector with K components. The post-logit noise term 214 may be based on a K×K covariance matrix. Furthermore, the post-logit noise term 214 may be based on a stochastic sampling process (e.g., a Monte-Carlo (MC) sampling process). The logit+noise vector 216 (e.g., with K components) may be provided to an activation function 218, to generate a probability vector 220 (e.g., with K components). The activation function 218 may be referred to as a probability-generating function or a probability-generating activation function. The probability vector 220 may be referred to as a classifier vector. In some embodiments, the activation function 218 may be a sigmoid function. In other embodiments, the activation function 218 may be a softmax function.

More particularly, the HET classifier model 200 performs a classification task, where a classifier:

$$softmax ( {W}^{T} ϕ ( x ; θ ) ) or sigmoid ( {W}^{T} ϕ ( x ; θ ) ) \qquad ( 1 )$$

is learned based on training data [symbol] ={(xₙ,yₙ)}ₙ₌₁^{N}. A training pair (xₙ, yₙ) corresponds to an input xₙ, e.g., an image, together with its label yₙ ∈{0,1}^{K} belonging to one, or multiple, of the K classes, in the multi-class and multi-label settings, respectively. The pre-noise logit function 208 is parametrized by W∈ [symbol] ^{D×K} and the D-dimensional representation ϕ (·; θ) output by a neural network (e.g., the pre-logit embedding model 204) with parameters θ. A bias term has been omitted for clarity. Throughout, the pre-noise logit vector 210 (e.g., W^{T} ϕ (x;θ) ∈ [symbol] ^{K}) may be referred to as the logit. The pre-logit vector 206 (e.g., ϕ (x;θ) ∈ [symbol] ^{D}), may be referred to as a pre-logit. An elementwise product (e.g., a Hadamard product) between like-tensors (e.g., matrices, vectors, and the like) may be indicated by the notation ∘.

Heteroscedastic classifiers (including HET 200) may learn an additional input-dependent noise distribution placed on the logits to capture uncertainty in the predictions of the model. The input-dependent noise distribution is employed to calculate the post-logit noise term 214. In the various embodiments, a multi-variate Gaussian distribution is used for the input-dependent noise distribution:

$${𝔼}_{ε} [ σ ( {W}^{T} ϕ ( x ; θ ) + ε ( x ) ) ] ∈ {ℝ}^{K} with ε ( x ) ∈ {ℝ}^{K} ∼ 𝒩 ( 0 , Σ ( x ; {θ}_{c o v} ) ) , \qquad ( 2 )$$

where σ can be either the softmax or the sigmoid transformation (e.g., the activation function 218). The covariance matrix Σ(x; θ_{cov}) of ε (e.g., the post-logit noise term 214) that is parametrized by θ_{cov}. The parameterization of Σ is described further below. The resulting conditional probability p(y|x; {W, θ, θ_{cov}}) in equation (2) is used to train the model on D by maximum likelihood and to make predictions at evaluation time.

As shown in equation (2), marginalizing over the noise ε(x) may be employed in heteroscedastic modelling. In some embodiments, the corresponding expectation may not be solved analytically. Rather, the post-logit noise module 212 may employ a Monte Carlo (MC) sampling process to estimate the post-logit noise term 214 by sampling from [symbol] (0,Σ(x; θ_{cov})).

Equation (2) may be related to a generative process that employs σ to approximate a discrete choice for classification. A temperature parameter τ>0 may be employed to control this approximation. More precisely, σ in equation (2) may be replaced by σ_{τ} so that σ_{τ}(u)=σ(1/τ·u). In various embodiments, t may be employed to regulate a bias-variance trade-off between the bias with respect to the generative process and the variance of the MC estimate. In some embodiments, t may be tuned on a held-out set of training data and the test performance is sensitive to its choice.

The “logits-before-noise” covariance matrix Σ(x; θ_{cov}) ∈ [symbol] ^{K×K} enables the HET model 200 to learn which regions of the input space have noisy labels and what the correlations across classes are in those regions. In the following discussion directed towards the parameterization of the covariance matrix, when clear from the context, explicit reference to the parameters θ_{cov} may be omitted.

Σ(x) may be made dependent on the input objects (e.g., input object 202). It may be assumed that the matrix decomposition Σ(x)=L(x)^{T}L(x) is positive definite with the full-rank matrix L(x) ∈ [symbol] ^{K×K} that may be vectorized as vec (L(x)) ∈ [symbol] ^{K}^{²}. Due to the large number of elements in θ_{cov}={C} (for instance, in some embodiments K=29,593 and D=2048), it may not be feasible to use a linear transformation of the D-dimensional pre-logits to parameterize vec(L(x)) as

$$vec ( L ( x ) ) = C ϕ ( x ; θ ) ∈ {ℝ}^{{K}^{2}} with C ∈ {ℝ}^{{K}^{2} \times D} . \qquad ( 3 )$$

In some embodiments, Σ(x) may be restricted to be a diagonal matrix, scaling down C to [symbol] ^{K×D}, but this may result in a drop in performance. Instead, a low-rank parametrization, with R<<K, of the form

$$Σ ( x ) = {V ( x )}^{T} V ( x ) + diag ( d ( x ) ) with V ( x ) ∈ {ℝ}^{R \times K} and d ( x ) ∈ {ℝ}_{+}^{K} \qquad ( 4 )$$

may offer a good trade-off between memory footprint and performance of the classifier. In that case, using a linear transformation of the pre-logits, as above, leads to θ_{cov} of size [symbol] (DKR+DK). In some embodiments, a further optimized parametrization whereby V(x)=J∘(1_{R}V(x)^{T}) where J∈ [symbol] ^{R×K} and v(x)∈ [symbol] ^{K}, with θ_{cov} thus scaling in [symbol] (DK+KR) is considered. The complexity [symbol] (DK+KR) may remain restrictive for modern large models and problems with a large number of classes.

Heteroscedastic classifiers, such as HET classifier model 200 result in impressive performance gains (e.g., over deterministic (DET) classifier models) across many tasks, e.g., large-scale classification tasks with many classes. However, their additional parameter count (e.g., compared to DET classifiers) scales linearly in the number of classes K. The increase in parameter count and corresponding memory use can be large relative to the performance gains.

### “Noise-Before-Logits” HET Classifier Models

FIG. 2B depicts a block diagram of a second example of a heteroscedastic (HET) classifier model 240, according to various embodiments. In the language used above, HET classifier model 240 may be a “noise-before-logits” and/or a “scalable” HET classifier model. Various components of HET classifier model 240 are similar to the components of HET classifier model 200 of FIG. 2A. A critical difference between HET classifier model 200 and HET classifier model 240 is that the order of the generating the logits and adding noise is reversed in HET classifier model 240. For instance, in HET classifier model 240, noise is added before the logits are calculated. As discussed below, this enables employing a significantly smaller covariance matrix. As such, HET classifier model 240 has a significant reduction in training and deployment costs (e.g., over HET classifier model 200), and includes increased performance.

Details of HET classifier model 240 are discussed in detail below. However, briefly, HET classifier model 240 includes a pre-logit embedding model 244 that receives an input object 242. The input object 242 may be referred to as x. The pre-logit embedding model 244 (e.g., ϕ (;θ)) may be parameterized by a vector of parameters θ. Based on the input object 242, the pre-logit embedding model 244 generates a pre-logit vector 246 (e.g., ϕ (x;θ)). The pre-logit vector 246 may be embedded within a D-dimensional pre-logit vector space, where D is a positive integer.

HET classifier model 240 includes a pre-logit noise module 252. As shown in FIG. 2B, the pre-logit vector 246 is provided to the pre-logit noise module 252. In contrast to the post-logit noise module 212 of FIG. 2A, the pre-logit noise module 252 introduces noise to each component of the pre-logit vector 246, which is a D-dimensional vector rather than a K-dimensional vector, where D<K. The pre-logit noise term 254 (e.g., ε′ (x)) adds noise to each component of the pre-logit vector 246 (e.g., embedded in the D-dimensional pre-logit space) to generate a pre-logit+noise vector 256 (e.g., embedded in the D-dimension pre-logit space). The pre-logit noise term 254 may be based on a D×D covariance matrix. Furthermore, the pre-logit noise term 254 may be based on a stochastic sampling process (e.g., a Monte-Carlo (MC) sampling process).

The pre-logit+noise vector 256 is provided to a post-noise logit function 248 (e.g., W^{T}). The post-noise logit function 248 generates a logit+ vector 250. The logit+noise vector 250 may be embedded in a K-dimensional post-logit vector space, where K is a positive integer that corresponds to the number of classes associated with the HET classifier model 200. In various embodiments, D<K. In at least one embodiment, D<<K. The logit+noise vector 250 may be provided to an activation function 258, to generate a probability vector 260. The probability vector 260 may be referred to as a classifier vector. In some embodiments, the activation function 258 may be a sigmoid function. In other embodiments, the activation function 258 may be a softmax function. The activation function 258 may be referred to as a probability-generating function, or a probability-generating activation function.

As noted above, the additional parameter count of HET classifier model 200 of FIG. 2A compared to deterministic (DET) classifiers scales in [symbol] (DK+KR) because the noise term ε is directly parameterized in the logit space with dimension K. In contrast to HET classifier 200 of FIG. 2A, HET classifier 240 of FIG. 2B directly injects the noise term (e.g., the pre-logit noise term 254) in the pre-logits ϕ(x;θ)∈ [symbol] ^{D} (e.g., pre-logit vector 246). The post-noise logit function 248 (e.g., a linear transformation W∈ [symbol] ^{D×K}) may be employed to transform the pre-logits to the logits. As such, the pre-logit noise term 254 is not dependent on the number of classes K. Thus, the analog of equation (2) for HET classifier model 240 is equation (5):

$${𝔼}_{{ε}^{′}} [ σ ( {W}^{T} ( ϕ ( x ; θ ) + {ε}^{′} ( x ) ) ) ] with {ε}^{′} ( x ) ∈ {ℝ}^{D} ∼ 𝒩 ( 0 , {Σ}^{′} ( x ; {θ}_{c o v} ) ) , \qquad ( 5 )$$

where ε′ ∈ [symbol] ^{D} and the covariance matrix Σ′(x; θ_{cov}) ∈ [symbol] ^{D×D} apply to the pre-logits. Therefore, the D×D covariance matrix (e.g., Σ′) may be parameterized as discussed above. The additional parameter count of θ_{cov} compared to DET scales in [symbol] (D²+DR) and [symbol] (D²R), respectively. In large-scale settings D is often small relative to K. In one example embodiment, K=29,593 while D=1024 or D=2048.

Properties of Gaussian distributions under linear transformations, W^{T} (ϕ (x;θ)+ε′ (x)) still defines a Gaussian distribution in logit space: [symbol] (W^{T} ϕ (x;θ), W^{T}Σ′(x)W). However, the covariance matrix, or some decomposition thereof, may not be explicitly computed in this space. It can be shown that the choice of sharing the W transformation between the pre-logits and the noise samples does not sacrifice performance compared to separate transformations W^{T} ϕ(x;θ)+(W′)^{T}ε′(x). In some extreme classification tasks, where K may be in the millions, the standard matrix-vector multiplication W^{T}ϕ(x;θ) may be replaced by a more scalable logic, involving for instance a distributed lookup of the active classes.

### Training the Temperature Parameter

As noted above, the temperature parameter (e.g., τ) of HET classifier models (e.g., HET classifier model 240) controls a bias-variance trade-off. The resulting performance is sensitive to the value of τ whose choice is often dataset-dependent. In some embodiments, a somewhat optimized value for τ may be determined via a hyperparameter sweep. However, hyperparameter sweeps may become prohibitively expensive to run at large scales. At the same time, bypassing this step or making the sweep too coarse may degrade performance.

To overcome these difficulties, in some embodiments, a value for the temperature parameter is “learned” (e.g., automatically tuned) during training. In some embodiments, the “training” or “learning” of τ for HET classifier 240 of FIG. 2B may be performed in a setting that includes a ResNet50x2 model on ImageNet-21k trained for 7 epochs. This setting is representative of the large-scale tasks, although slightly scaled down, both in terms of model size and training regime.

Methods that tune τ based on multiple successive trainings are considered. In particular, a grid search (GS) (assuming a grid of values for τ) and Bayesian optimisation (BO) are considered for various embodiments.

Given that τ may be a one-dimensional continuous parameter, approaches that optimize a validation objective by gradient descent, typically following a bi-level formulation, may be considered. For gradient descent approaches, costly high-order derivatives that account for the dependency of the hyperparameters may be approximated in the validation objective. In at least one embodiment, a gradient-based method that considers the hyperparameter dependency through the current training step gradient is employed. Moreover, because of the particular structure of τ—explicitly appearing both at training and validation time, unlike optimization-related or regularization-related hyperparameters that surface only at training time—a simpler alternative gradient estimator may be evaluated in various embodiments. Thus, in the various embodiments, the temperature parameter (τ) may be trained like any other model parameter.

### Example Methods

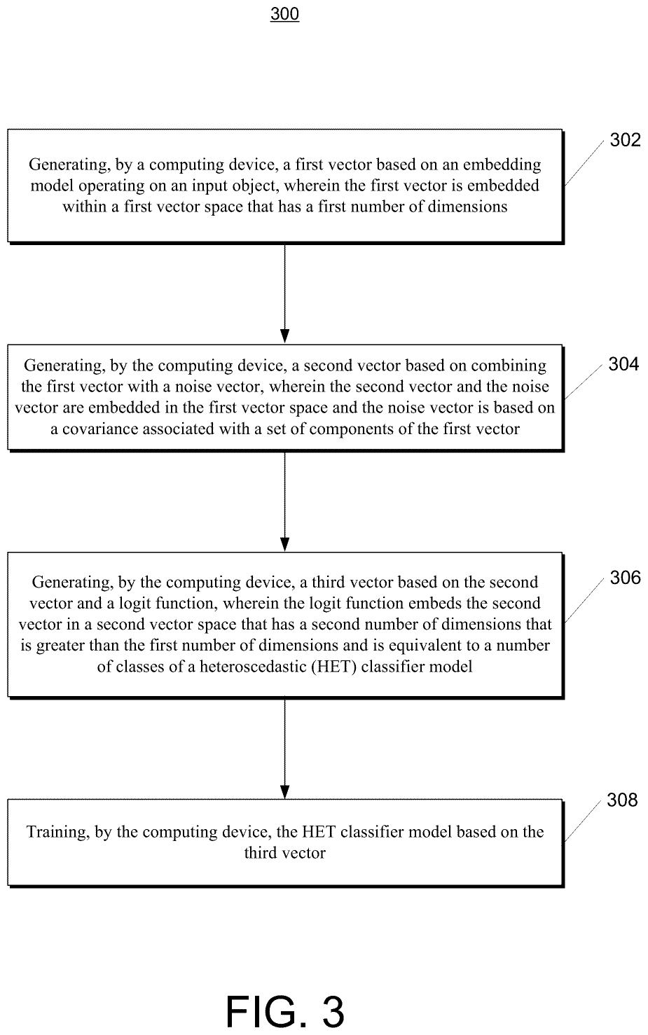

FIG. 3 depicts a flow chart diagram of an example method 300 to train a heteroscedastic classifier model according to example embodiments of the present disclosure. Although FIG. 3 depicts steps performed in a particular order for purposes of illustration and discussion, the methods of the present disclosure are not limited to the particularly illustrated order or arrangement. The various steps of the method 300 can be omitted, rearranged, combined, and/or adapted in various ways without deviating from the scope of the present disclosure. The HET classifier model trained in method 300 may be similar to HET classifier model 240 of FIG. 2B. Accordingly, the HET classifier model may be a “noise-before-logits” HET classifier model.

At 302, a computing device (or system) may generate a first vector (e.g., pre-logit vector 246 of FIG. 2B) based on an embedding model (e.g., pre-logit embedding model 244 of FIG. 244) operating on an input object (e.g., input object 242 of FIG. 2B). The first vector may be embedded within a first vector space (e.g., a pre-logit vector space) that has a first number of dimensions (e.g., D).

At 304, the computing device may generate a second vector (e.g., pre-logit+noise vector 256 of FIG. 2B) based on combining the first vector with a noise vector (e.g., pre-logit noise term 254 of FIG. 2B, ε′ (x)). The second vector and the noise vector are embedded in the first vector space. The noise vector is based on a covariance (e.g., a D×D covariance matrix) associated with a set of components of the first vector.

At block 606, the computing device may generate a third vector (e.g. pre-logit+noise vector 256 of FIG. 2B) based on the second vector and a logit function (e.g., post-noise logit function 248 of FIG. 2B). The logit function embeds the second vector in a second vector space (e.g., a logit vector space) that has a second number of dimensions (e.g., K) that is greater than the first number of dimensions (e.g., K>D) and is equivalent to a number of classes (e.g., K) of the HET classifier model.

At block 608, the computing device may train the HET classifier model based on the third vector.

In some embodiments, the covariance associated with the set of components of the first vector may be based on a multivariate Gaussian distribution (e.g., ε′ (x)∈ [symbol] ^{D}˜ [symbol] (0,Σ′(x; θ_{cov}))). The multivariate Gaussian distribution may have a separate random variable associated with each component of the set of components of the first vector and the covariance is a covariance between the separate random variables.

In various embodiments, each component of the third vector corresponds to a separate class of the number of classes of the HET classifier model. The method may further include generating a fourth vector (e.g., probability vector 260 of FIG. 2B) based on an activation function (e.g., the activation function 258 of FIG. 2B). The fourth vector is embedded in the second vector space and an activation function transforms each component of the third vector into a probability value such that each component of the fourth vector corresponds to a separate class of the number of classes and is equivalent to the probability value corresponding to the class. In some embodiments, the activation function is a softmax function. In other embodiments, the activation function is a sigmoid function.

In some embodiments, the method includes transforming each component of the third vector based on a temperature parameter (e.g., τ) of the HET classifier model. The computing device may generate the fourth vector transforming each component of the third vector based on a temperature parameter of the HET classifier model. In some embodiments, training the HET classifier model may include learning a value for the temperature parameter. The value for the temperature parameter may be learned by a gradient descent algorithm.

The covariance associated with the set of components of the first vector may be encoded in a covariance matrix. The covariance matrix has a number of rows equivalent to the first number of dimensions (e.g., D) and a number of columns that is equivalent to the first number of dimensions. The covariance matrix may be generated via a Monte Carlo sampling process.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computing system enabled to improve a computational efficiency of classifiers, the system comprising:
one or more processors; and
one or more non-transitory computer-readable media that store instructions that when executed by the one or more processors, cause the computer system to perform operations comprising:
generating a first vector based on an embedding model operating on an input object, wherein the first vector is embedded within a first vector space that has a first number of dimensions;
generating a second vector based on combining the first vector with a noise vector, wherein the second vector and the noise vector are embedded in the first vector space and the noise vector is based on a covariance associated with a set of components of the first vector;
generating a third vector based on the second vector and a logit function, wherein the logit function embeds the second vector in a second vector space that has a second number of dimensions that is greater than the first number of dimensions and is equivalent to a number of classes of a heteroscedastic (HET) classifier model; and
training the HET classifier model based on the third vector.

2. The computing system of claim 1, wherein the covariance associated with the set of components of the first vector is based on a multivariate Gaussian distribution that has a separate random variable associated with each component of the set of components of the first vector and the covariance is a covariance between the separate random variables.

3. The computing system of claim 1, wherein each component of the third vector corresponds to a separate class of the number of classes of the HET classifier model and the operations further comprise:
generating a fourth vector based on an activation function, wherein the fourth vector is embedded in the second vector space and the activation function transforms each component of the third vector into a probability value such that each component of the fourth vector corresponds to a separate class of the number of classes and is equivalent to the probability value corresponding to the class.

4. The computing system of claim 3, wherein the activation function is a softmax function.

5. The computing system of claim 3, wherein the activation function is a sigmoid function.

6. The computing system of claim 3, wherein the operations further comprise:
transforming each component of the third vector based on a temperature parameter of the HET classifier model; and
generating the fourth vector transforming each component of the third vector based on a temperature parameter of the HET classifier model.

7. The computing system of claim 1, wherein training the HET classifier model includes learning a value for a temperature parameter.

8. The computing system of claim 7, wherein the value for the temperature parameter is learned by a gradient descent algorithm.

9. The computing system of claim 1, wherein the covariance associated with the set of components of the first vector is encoded in a covariance matrix that has a number of rows equivalent to the first number of dimensions and a number of columns that is equivalent to the first number of dimensions.

10. The computing system of claim 9, wherein the covariance matrix is generated via a Monte Carlo process.

11. A computer-implemented method comprising:
generating, by a computing device, a first vector based on an embedding model operating on an input object, wherein the first vector is embedded within a first vector space that has a first number of dimensions;
generating, by the computing device, a second vector based on combining the first vector with a noise vector, wherein the second vector and the noise vector are embedded in the first vector space and the noise vector is based on a covariance associated with a set of components of the first vector;
generating, by the computing device, a third vector based on the second vector and a logit function, wherein the logit function embeds the second vector in a second vector space that has a second number of dimensions that is greater than the first number of dimensions and is equivalent to a number of classes of a heteroscedastic (HET) classifier model; and
training, by the computing device, the HET classifier model based on the third vector.

12. The method of claim 11, wherein the covariance associated with the set of components of the first vector is encoded in a covariance matrix that has a number of columns that is equivalent to the first number of dimensions and has a number of rows that is equivalent to the first number of dimensions.

13. The method of claim 11, wherein each component of the third vector corresponds to a separate class of the number of classes of the HET classifier model and the method further comprise:
generating a fourth vector based on an activation function, wherein the fourth vector is embedded in the second vector space and the probability function transforms each component of the third vector into a probability value such that each component of the fourth vector corresponds to a separate class of the number of classes and is equivalent to the probability value for the corresponding class.

14. The method of claim 13, wherein the activation function is a softmax function.

15. The method of claim 13, wherein the activation function is a sigmoid function.

16. One or more non-transitory computer-readable media that store instructions that, when executed by one or more processors, cause the one or more processors to perform operations comprising:
generating a first vector based on an embedding model operating on an input object, wherein the first vector is embedded within a first vector space that has a first number of dimensions;
generating a second vector based on combining the first vector with a noise vector, wherein the second vector and the noise vector are embedded in the first vector space and the noise vector is based on a covariance associated with a set of components of the first vector;
generating a third vector based on the second vector and a logit function, wherein the logit function embeds the second vector in a second vector space that has a second number of dimensions that is greater than the first number of dimensions and is equivalent to a number of classes of a heteroscedastic (HET) classifier model; and
training the HET classifier model based on the third vector.

17. The computer-readable media of claim 16, wherein each component of the third vector corresponds to a separate class of the number of classes of the HET classifier model and the operations further comprise:
generating a fourth vector based on an activation function, wherein the fourth vector is embedded in the second vector space and the activation function transforms each component of the third vector into a probability value such that each component of the fourth vector corresponds to a separate class of the number of classes and is equivalent to the probability value corresponding to the class.

18. The computer-readable media of claim 17, wherein the operations further comprise:
transforming each component of the third vector based on a temperature parameter of the HET classifier model; and
generating the fourth vector based on each transformed component of the third vector.

19. The computer-readable media of claim 16, wherein the operations further comprise:
deploying the HET classifier model for an image classification task.

20. The computer-readable media claim 16, wherein the operations further comprise:
deploying the HET classifier model for a multi-armed bandit task.
